(19) United States
(12) Patent Application Publication
(10) Pub. No.: US 2005/0246979 A1
(43) Pub. Date: Nov. 10, 2005

(54) Corner transmission assembly for safety against improper operations for metallic window and door frames with swivel wing

(75) Inventor: Aimone Balbo Di Vinadio, Torino (IT)

Correspondence Address: HESLIN ROTHENBERG FARLEY & MESITI PC, 5 COLUMBIA CIRCLE, ALBANY, NY, 12203, US

(73) Assignee: SAVIO S.p.A., Chiusa San Michele (Torino) (IT)

(21) Appl. No.: 11/122,639

(22) Filed: May 5, 2005

(30) Foreign Application Priority Data
May 5, 2004 (IT) TO2004A000288

(51) Int. Cl. B60G 1/00

(52) U.S. Cl. 52/204.1

(57) ABSTRACT

A corner and safety transmission assembly for an actuating linkage of a metallic window or door frame with wing and swivel opening, which includes an “L” shaped guiding body able to be fastened on the exterior of an upper corner of the movable frame of the window or door; a first and a second slidable member, mounted slidable on respective branches of the guiding body; a flexible element that interconnects said slidable members; and a safety block including a body in which is mounted a bolt able to slide transversely relative to the direction of motion of the first slidable member and against the action of elastic means. The guiding body has two transverse guides between which is inserted the body of the safety block. The first slidable member has two segments with different heights and the body of the safety block has on one side oriented towards the guiding body an opening directed in the longitudinal direction engageable by the segment with greater height of the slidable member to prevent a motion in the transverse direction of the body of the safety block.

### CROSS-REFERENCE TO RELATED APPLICATIONS

This application claims priority from Italian Patent Application No. TO2004A000288 filed on May 5, 2004, the entire disclosure of which is incorporated herein by reference.

### FIELD OF THE INVENTION

The present invention relates to accessories for metallic window and door frames constituted by light alloy section bars and in particular it pertains to a corner and safety transmission assembly for an actuating linkage of a metallic window or door frame with swivel wing.

### SUMMARY OF THE INVENTION

These frames are provided with a cremone bolt handle coupled with a linkage that is able to lock the movable frame in a closed position or to allow the wing opening by rotation around a vertical side or swivel opening by rotation around the lower horizontal side.

To the actuating linkage is associated a safety block whose function is to prevent the linkage from being operated by means of the handle when the window or door is open in wing or swivel mode.

A corner transmission assembly provided with such a safety block is disclosed in Italian utility model no. 213023 by the same Applicant.

The object of the present invention is to provide a corner and safety transmission assembly which enables to simplify the process of mounting the safety block on the frame with respect to the known solution described in the Italian utility model no. 213023.

According to the present invention, said object is achieved by a corner transmission assembly having the characteristics set out in the claims.

### BRIEF DESCRIPTION OF THE DRAWINGS

The present invention shall now be described in detail with reference to the accompanying drawings, provided purely by way of non limiting example, in which:

FIG. 1 is a perspective view of a transmission assembly according to the present invention,

FIG. 2 is a perspective view of the transmission assembly of FIG. 1 without the safety block,

FIGS. 3 and 4 are perspective views of the safety block viewed from its lower side, respectively in the locked position and in the unlocked position,

FIG. 5 is a partial plan view of the transmission assembly in the position for mounting the safety block,

FIG. 6 is a section according to the line VI-VI of FIG. 5,

FIG. 7 is a plan view of the transmission assembly in working position, and

FIG. 8 is a section according to the line VIII-VIII of FIG. 7.

### DETAILED DESCRIPTION OF THE DRAWINGS

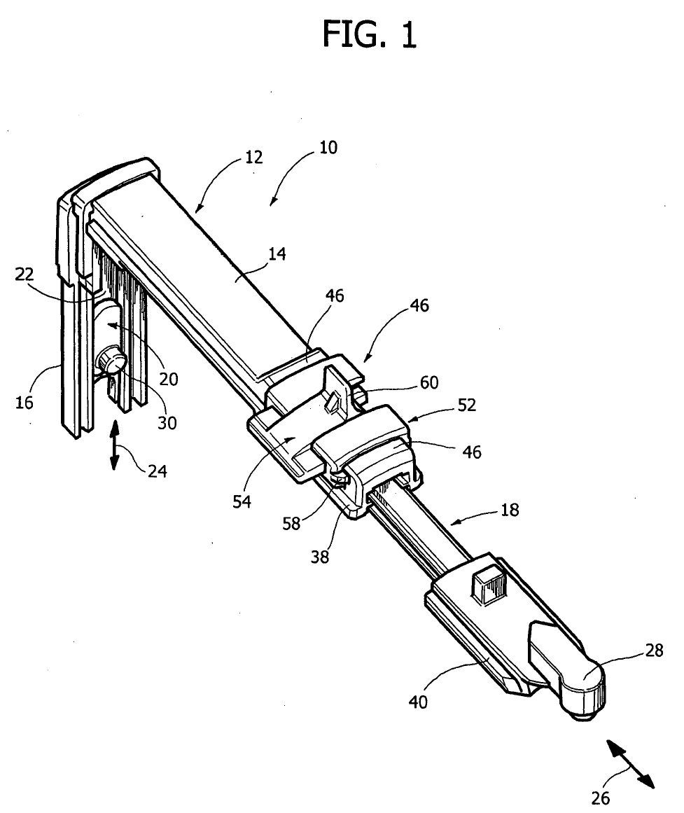

With reference to FIG. 1, the number 10 designates a safety corner transmission assembly according to the present invention. The transmission assembly 10 is intended for use on metallic window or door frames with swivel wing. In particular, the transmission assembly 10 is mounted on the movable frame, in the upper openable corner region, i.e. in the region that can be removed from the fixed frame both in the wing and in the swivel opening mode. The transmission assembly 10 comprises a guiding body 12 made of metallic or plastic material with an “L” shape, provided with two mutually orthogonal branches 14, 16. The two branches 14, 16 are provided with respective longitudinal guides engaged by respective slidable members 18, 20. In known fashion, the two slidable members 18, 20 are fastened at the opposite ends of a flexible metallic element 22 formed, for example, by three metallic laminas, which extends along the two branches 14, 16 of the guiding body 12 and which is able to actuate the sliding of the slidable member 20 in the direction indicated by the double arrow 24 in FIG. 1 as a result of the movement of the slidable member 18 in the direction indicated by the double arrow 26 in the same figure. The two slidable members 18, 20 are provided with respective connecting elements 28, 30 for connection to transmission rods (not shown) of the control linkage.

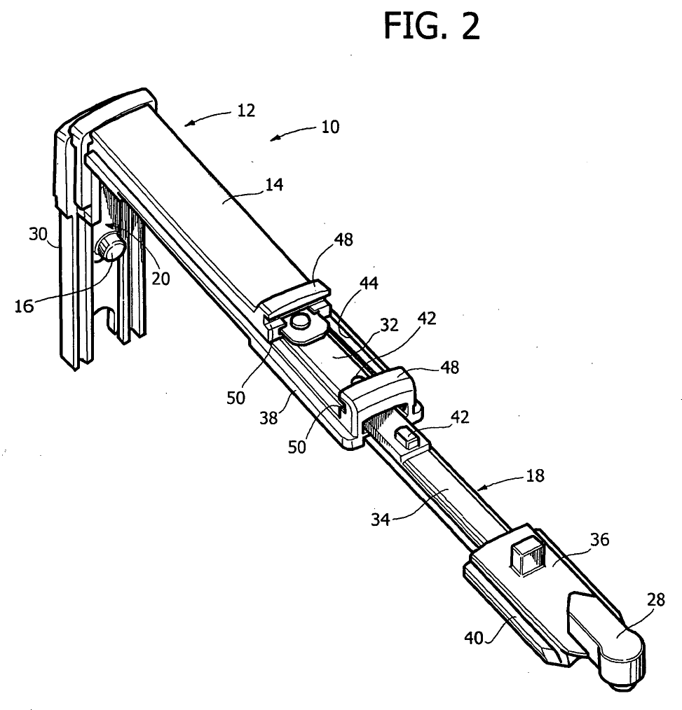

With reference in particular to FIG. 2, the slidable member 18 comprises a part shaped as a rod subdivided into two segments 32, 34 with a different height with respect to the sliding plane of the member 18. In particular, the segment 32 has an upper surface positioned at a greater height than the upper surface of the segment 34. The segment 34 bears at its distal end an element 36 with greater width whereon is formed the connecting portion 28. The branch 14 of the guiding body 12 and the broadened element 36 of the slidable element 18 are provided with lateral wings 38, 40 for engagement within the edges of a groove of the metallic section bar which constitutes an upright of the movable frame.

The segment with greater height 32 of the slidable member 18 is provided with engagement formations 42 constituted by two integral elements which project from the upper surface of the segment 32.

The guiding body 12 has, at an end of the branch 14, a seat 44 (FIG. 2) able to receive a safety block 46. With reference in particular to FIG. 2, the seat 44 has a through central opening and two transverse guiding elements 48 provided with respective transverse channel guides 50.

With reference to FIGS. 1, 3 and 4, the safety lock 46 comprises a body 52, made of plastic or metallic material, a bolt 54 slidable relative to the body 52 and a pair of helical compression springs 56 positioned between the body 52 and the bolt 54 and tending to thrust the bolt 54 towards a locked position.

The body 52 of the safety block 46 has two parallel outer ribs 58 which slidably engage the transverse guides 50 of the guiding body 12. The bolt 54 is made of metallic or plastic material and it has an actuating portion projecting superiorly 60 which co-operates with the fixed frame of the window or door. On its lower surface, the bolt 54 is provided with an engagement formation 62 that is destined to co-operate in arresting relationship with the engagement formations 42 of the slidable member 18.

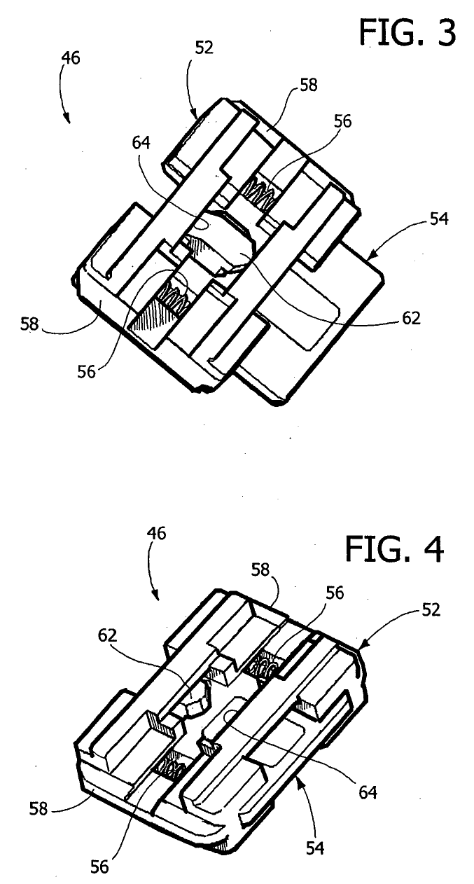

The body 52 of the safety block 46 has on its lower side (see FIGS. 3 and 4) an opening with longitudinal development able to receive the segment 32 with greater height of the slidable member 18.

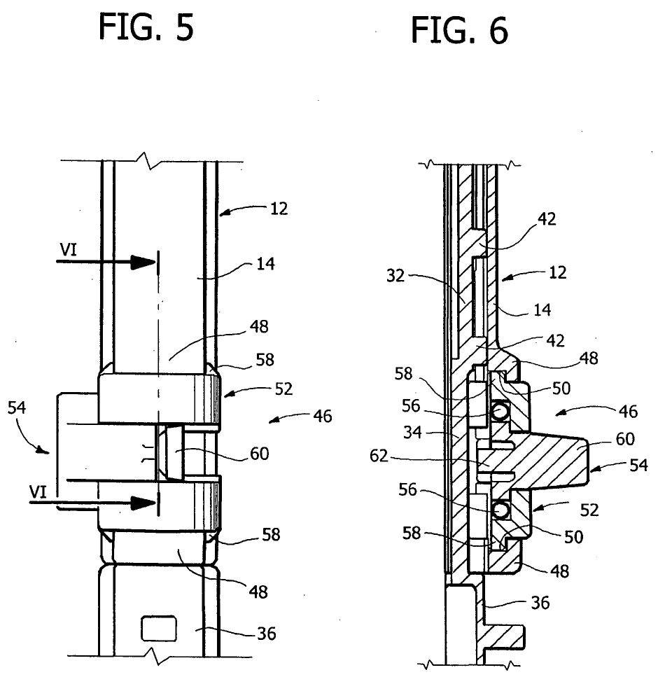

FIGS. 5, 6 and 7, 8 illustrate the manner in which the safety block 46 is mounted on the guiding body 12. To mount the safety block 46, it is necessary to thrust the slidable member 18 in its recessed position with respect to the guiding body 14. In this position, the segment 34 with smaller height of the slidable member 18 is positioned at the seat 44 able to receive the safety block 46. The safety block 46 can thus be inserted into the seat 44 with a movement in the transverse direction positioning the ribs 58 of the safety block 46 into the corresponding transverse guides 50 of the guiding body 12.

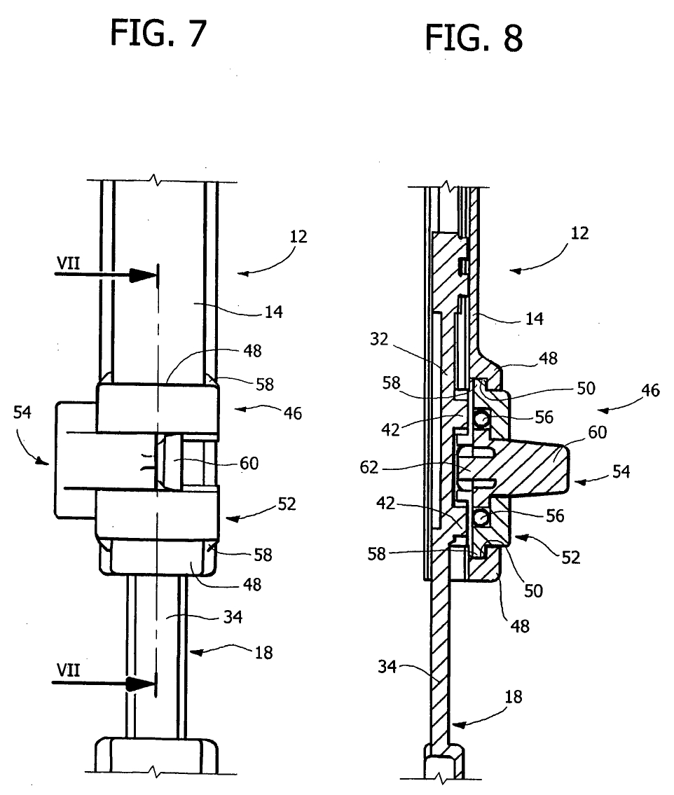

It should be noted that the safety block can be mounted indifferently in the position illustrated in FIGS. 5 and 7 or in a position that is offset by 180° relative to the illustrated position. This makes the safety block 46 reversible and usable indifferently with rightward or leftward opening windows or doors.

After inserting the safety block as shown in FIGS. 5 and 6, the mounting operation is completed by thrusting the bolt 54 towards the unlocked position and, simultaneously, extracting the slidable member 18 from the guiding body 12. The position illustrated in FIGS. 7 and 8 is thus reached and mounting is completed.

The safety block 46 is stably fastened to the guiding body 12 because the engagement of the segment with greater height 32 of the slidable member 18 with the longitudinal opening 64 of the safety block 46 prevents a displacement in the transverse direction of the body 52 of the safety block 46.

In the assembled position, the safety block 46 forms an integral part of the transmission assembly and is not to be mounted as an autonomous component on the upright of the window or door frame. The procedure for mounting the corner transmission assembly is greatly simplified with respect to the known solution described in the Italian utility model no. 213023 by the same Applicant.

In use, when the movable frame of the window or door is in the open position, the bolt 54 of the safety block 46 is in its blocking position, illustrated in FIGS. 7 and 8. In this position, the engagement formation 62 of the bolt 54 extends through the displacement trajectory of the engagement formations 42 of the slidable member 18 and prevents the slidable member 18 from completing its work travel.

When the movable frame of the window or door is in a closed position, the bolt 54 moves towards an unlocked position against the action of the elastic means 56 as a result of the engagement of the projection 60 of the bolt 54 against the fixed frame. In the unlocked position of the bolt 54, the engagement formations 62 and 42 are misaligned and the slidable member 18 is free to complete its work travel.

Naturally, without altering the principle of the invention, the construction details and the embodiments may be widely varied from what is described and illustrated herein, without thereby departing from the scope of the invention as defined by the claims that follow.

1. A corner and safety transmission assembly for an actuating linkage of a metallic window or door frame with wing and swivel opening, comprising:
an “L” shaped guiding body adapted to be fastened on the exterior of an upper corner of the movable frame of the window or door,
a first and a second slidable member, mounted slidable on respective branches of the guiding body, the first slidable member being provided with engagement formations,
a flexible element that interconnects said slidable members, and
a safety block including a body in which is mounted a bolt slidable transversely relative to the direction of motion of the first slidable member and against the action of elastic means, in which the bolt is able to occupy a locking position in which it co-operates with said engagement formations and an unlocking position in which it does not co-operate with said engagement formations, the bolt being thrust into the unlocking position against the action of the elastic means as a result of the engagement with the fixed frame when the window or door is closed,
wherein the guiding body has two transverse guides between which is inserted the body of the safety block, and in which the first slidable member has two segments with different heights, the body of the safety block having on one side oriented towards the guiding body an opening directed in the longitudinal direction engageable by the segment with greater height of the slidable member to prevent a movement in the transverse direction of the body of the safety block.

2. Transmission assembly as claimed in claim 1, wherein the safety block is configured to be selectively mounted on the guiding body in two positions, offset by 180° with respect to each other to adapt the transmission assembly to rightward opening or leftward opening window or door frames.

3. Transmission assembly as claimed in claim 2, wherein the body of the safety block is provided with two transverse ribs that engage said transverse guides of the guiding body.
